(19) United States
(12) Patent Application Publication
(10) Pub. No.: US 2004/0087677 A1
(43) Pub. Date: May 6, 2004

(54) Method for graft polymerization to polymer substrate

(76) Inventors: Takanobu Sugo, Gunma (JP); Noriaki Seko, Gunma (JP); Kunio Fujiwara, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/467,919

(22) PCT Filed: Feb. 22, 2002
(86) PCT No.: PCT/JP02/01606

(30) Foreign Application Priority Data
Feb. 22, 2001 (JP) 2001-46519

(51) Int. Cl. C08J 3/28

(52) U.S. Cl. 522/3

(57) ABSTRACT

The present invention aims to provide a graft polymerization method that can be applied to even organic polymer substrates having relatively low strength while overcoming the problem of inhomogeneous grafting.

Graft polymerization methods of the present invention comprises performing graft polymerization by bringing an irradiated organic polymer substrate into contact with a polymerizable monomer wherein the organic polymer substrate is continuously or intermittently moved with slack during graft polymerization.

### FIELD OF THE INVENTION

The present invention relates to improvements in radiation-induced graft polymerization onto organic polymer substrates.

### PRIOR ART

Radiation-induced graft polymerization is a technique in which an organic polymer substrate is irradiated with an ionizing radiation to form a radical and a polymerizable monomer is grafted to the radical moiety. It has recently drawn interest as a means for preparing separation functional materials because functional groups can be introduced into various forms of polymers. Especially, radiation-induced graft polymerization is interesting as a means for preparing air-cleaning chemical filter materials that are recently often used for cleaning the air in clean rooms in precision electronics industries such as semiconductor industry or pharmacy and as a means for preparing ion exchange filter materials used in water purifiers.

Radiation-induced graft polymerization is classified into liquid phase graft polymerization, gas phase graft polymerization and impregnation graft polymerization according to the manner of contact between an irradiated polymer substrate (irradiated substrate) and a monomer.

In liquid phase graft polymerization, graft polymerization reaction is performed on an irradiated substrate impregnated with a monomer solution. Liquid phase graft polymerization ensures homogeneous graft polymerization, but it has the disadvantage of high running costs because large amounts of monomers and washing chemicals are consumed. In addition, the amounts of monomers and washing chemicals widely vary with the form of the substrate. When a fibrous substrate such as a woven or nonwoven fabric is used, for example, much labor is required for washing operation because it is very hard to dehydrate. When a porous substrate is used, large amounts of washing chemicals are required and the washing period is prolonged because they continue to leak from small pores of the substrate for a long period. Thus, considerably high running costs are required for liquid graft polymerization onto substrates other than non-porous particles or membranes. Even when a fibrous substrate is used, liquid phase graft polymerization has the disadvantage that the substrate is swollen to lose strength and eventually severed in the graft polymerization apparatus because the substrate is impregnated with a polymerizable monomer solution for a long period over a plurality of guide rolls. Especially, fibrous substrates have a high liquid-retaining tendency and become heavy by absorbing a considerable amount of a monomer solution, and therefore, liquid phase graft polymerization could be applied to only substrates having relatively high strength.

In gas phase graft polymerization, an irradiated substrate is brought into contact with a monomer in a gaseous state (vapor). This method is known to have an advantage in terms of costs because the monomer is used in a very little amount and the washing step can be eliminated or remarkably simplified though some care is required in the design of the polymerization apparatus. Gas phase graft polymerization also has the advantage that the grafting degree can be controlled by adjusting the monomer amount. However, gas phase graft polymerization is rarely performed today because it has the disadvantages that it can be applied to only monomers having a relatively high vapor pressure and that inhomogeneous grafting is liable to occur.

In impregnation graft polymerization, an irradiated substrate is impregnated with a predetermined amount of a monomer and reacted in vacuo or in an inert gas for graft polymerization. This impregnation graft polymerization method has several advantages, i.e., it is economical because the monomer used is almost completely reacted and less unreacted chemicals remain; the substrate is easy to handle and less waste liquor is produced because the substrate is obtained in a dry state after graft polymerization. Thus, it can be considered as a method combining the advantages of both liquid phase graft polymerization and gas phase graft polymerization, and it is very effective when the graft substrate is a permeable material such as a woven/nonwoven fabric. However, it has the disadvantage that it can be applied to only strong substrates in some cases, e.g., when a high grafting degree is required, because the substrate becomes extremely heavy once it is impregnated with in a large amount of a monomer solution.

The present invention aims to solve the problems with various types of graft polymerization as described above and to provide a graft polymerization method that can be applied to even organic polymer substrates having relatively low strength while overcoming the problem of inhomogeneous grafting.

### SUMMARY OF THE INVENTION

In order to solve the problems described above, the present invention relates to graft polymerization methods for polymer substrates comprising performing graft polymerization by bringing an irradiated organic polymer substrate into contact with a polymerizable monomer wherein the organic polymer substrate is continuously or intermittently moved with slack during graft polymerization.

### BRIEF DESCRIPTION OF THE DRAWINGS

FIG. 1 is a schematic view of a graft polymerization reactor according to an embodiment of the present invention.

FIG. 2 is a schematic view of a graft polymerization reactor according to another embodiment of the present invention.

FIG. 3 is a schematic view of a graft polymerization reactor according to still another embodiment of the present invention.

FIG. 4 is a schematic view of a graft polymerization reactor used in Comparative Example 1.

### DETAILED DESCRIPTION OF THE INVENTION

Radiations that can be used in graft polymerization methods of the present invention include α-rays, β-rays, γ-rays, electron rays, UV ray, etc., among which γ-rays and electron rays are preferred for use in the present invention. Radiation-induced graft polymerization includes preirradiation graft polymerization involving preliminarily irradiating a graft substrate and then bringing it into contact with a graft monomer for reaction, and simultaneous irradiation graft polymerization involving simultaneously irradiating a substrate and a monomer, and either method can be used in the present invention but the preirradiation method is more advantageous because the monomer is less homopolymerized.

Preferred examples of organic polymer substrates that can be used in graft polymerization methods of the present invention are organic polymer compounds including, but not limited to, polyolefins such as polyethylene and polypropylene; halogenated polyolefins such as PTFE and vinyl chloride; and olefin-halogenated olefin copolymers such as ethylene-tetrafluoroethylene copolymers and ethylene-vinyl alcohol copolymers (EVA).

These substrates can be in any form so far as they are sheet-like. For example, they can be suitably used in the form of a fibrous substrate such as a long sheet of a woven or nonwoven fabric or in the form of particles or powder supported on a film or fabric formed into a sheet.

Normally, graft polymerization is performed on such a sheet-like substrate by sequentially feeding the substrate into a graft polymerization reaction chamber where it is reacted at a predetermined temperature for a predetermined period under tension over guide rolls and then taken up on a wind-up roll. However, the substrate is frequently severed in the graft polymerization reaction chamber when a long period is required to complete the reaction or when a high grafting degree is desired. This is because the substrate is not strong enough to resist the tension from guide rolls.

In order to solve this problem, according to graft polymerization methods of the present invention, a substrate is continuously or intermittently moved with slack in a graft polymerization reaction chamber. Thus, no more tension is imposed on the substrate during graft reaction, so that graft reaction can sufficiently proceed even on substrates having low strength or fibrous or similar substrates liable to become heavy by impregnation with a large amount of a monomer solution such as fabrics and they are not severed during graft reaction. A suitable way for continuously or intermittently moving a substrate with slack may comprise detecting the tension and/or take-up speed at the wind-up roll on which the substrate is taken up after graft polymerization and controlling the feeding speed at the feed roll from which the substrate is fed to a graft polymerization reaction chamber in response to the detection.

Examples of specific embodiments of the present invention are explained below with reference to the attached drawings. The following explanation shows specific embodiments of the present invention, and the present invention is not limited thereto.

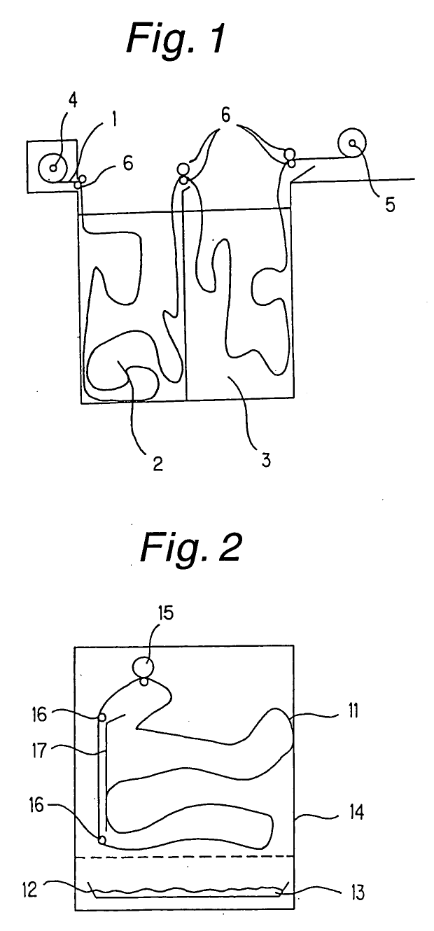

FIG. 1 shows an example in which a method of the present invention is applied to liquid phase graft polymerization. An irradiated substrate 1 is stocked on a feed roll 4 and fed into a monomer solution in a graft reaction bath 2. Substrate 1 reacts with the monomer while floating with slack in the monomer solution, and then it is sequentially sent to a washing bath 3 containing a washing liquid for washing off the monomer solution deposited to the substrate. The substrate is similarly moved while floating with slack in the washing liquid and taken up on a wind-up roll 5. Guide rolls (conveyance rolls) 6 are provided at the inlet of the graft reaction bath, between the graft reaction bath and the washing bath and at the outlet of the washing bath. The guide rolls (conveyance rolls) 6 have a function to guide the substrate as well as regulate conveying speed of the substrate to have the substrate conveyed with slack in each bath. Here, the substrate can be moved with slack in the graft reaction bath and the washing bath by controlling the feeding speed of feed roll 4, the take-up speed of wind-up roll 5 and the conveying speed of guide rolls 6. Feed roll 4, wind-up roll 5 and guide rolls 6 can be rotated continuously or intermittently. The graft polymerization reaction period and washing period can be adjusted by controlling the sizes of the graft polymerization bath and the washing bath, the length of slack in the substrate and the rotation speeds of feed roll 4, wind-up roll 5 and guide rolls 6. The number of guide rolls 6 can be reduced and the size of the apparatus can also be reduced because the substrate is moved with slack in graft reaction bath 2 and washing bath 3. According to the method of the present invention, a substrate can be transported with a very little force and therefore can be prevented from being severed by excessive tension because the substrate floats in each liquid even if the substrate is in the form of a very thin film or a woven/nonwoven cloth having a low areal density that would be swollen or retain liquids to lose strength during passage through the graft reaction bath and washing bath.

Next, FIG. 2 shows an example in which a method of the present invention is applied to gas phase graft polymerization. A band-like substrate 11 forming a ring with both ends joined together is endlessly moved in a reaction chamber 14 by the rotation of a feed roll 15. Feed roll 15 may be continuously or intermittently rotated. A vapor of a monomer is generated from a monomer solution tray 12 containing a monomer solution 13 at the bottom of the reaction chamber. A heater (not shown) may be provided under monomer solution tray 12 to promote monomer vapor generation. The substrate is moved with slack in reaction chamber 14. Guide rolls 16 and a guide plate 17 are provided to prevent entanglement of the substrate. Guide rolls 16 are provided to prevent entanglement of the substrate but impose no tension on the substrate. In such a graft polymerization reactor, inhomogeneous grafting would be liable to occur because a monomer vapor is emitted to rise from monomer tray 12 and parts of substrate 11 existing at the bottom of reaction chamber 14 tend to be in contact with a concentrated monomer vapor. According to the present invention, however, the substrate is moved by the rotation of feed roll 15 and returned to the original position after a period. Thus, the substrate is continuously or intermittently moved so that any part of the substrate can be homogeneously in contact with a monomer vapor. The substrate is prevented from being severed by excessive tension because it is moved with slack in reaction chamber 14.

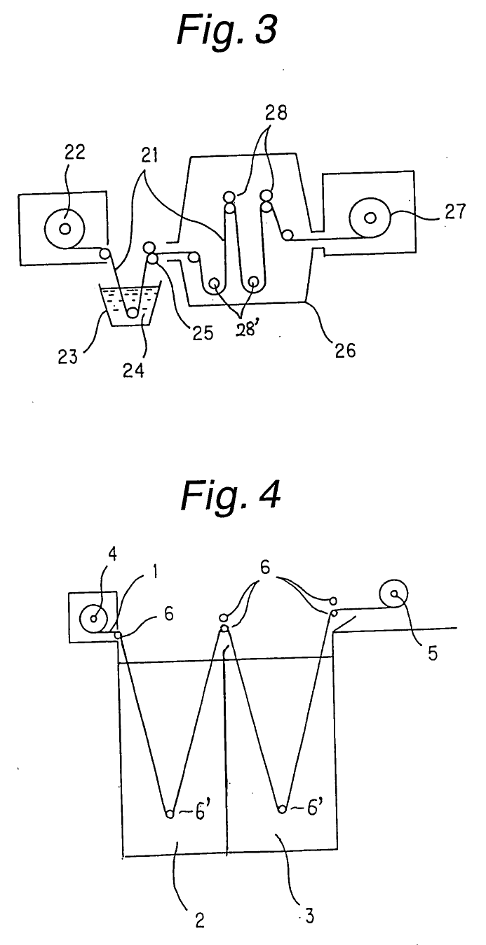

Next, FIG. 3 shows an example in which a method of the present invention is applied to impregnation graft polymerization. An irradiated substrate 21 is stocked on a feed roll 22 and fed into a monomer solution in a monomer impregnation bath 23 where the substrate is impregnated with a predetermined amount of a monomer with a wringer roll 25. Then, substrate 21 is reacted at a predetermined temperature for a predetermined period in a graft polymerization vessel 26 and then taken up on a wind-up roll 27. Guide rolls 28 and 28′ are provided in graft polymerization reaction vessel 26. The guide rolls 28 provided at upper portion of the vessel is used to guide the substrate as well as regulate the conveying speed of the substrate so that the substrate is transported in the reaction vessel 26 with slack. The guide rolls 28′ provided at lower portion of the vessel is used to smoothly feed the substrate in reaction vessel 26 by preventing entanglement of the substrate and to homogenize the reaction temperature but impose no tension on the substrate. Thus, the substrate is transported with slack in reaction vessel 26. In order to ensure this slack state, the tension and speed of wind-up roll 27 are detected and kept under predetermined values by controlling the rotation speeds of feed roll 22, wringer roll 25 and guide rolls 28. Each roll may be continuously or intermittently rotated. According to the method of the present invention, the substrate is transported with slack in the graft reaction vessel without excessive tension, so that graft reaction can sufficiently proceed and the substrate is not severed even when the substrate must be impregnated with a considerable amount of a monomer solution to obtain a high grafting degree and therefore, the substrate becomes considerably heavy after it is impregnated with the monomer solution, for example.

The present invention also relates to graft polymerization apparatuses illustrated in the embodiments described above. Accordingly, another aspect of the present invention relates to a graft polymerization apparatus for polymer substrates comprising a graft polymerization reaction chamber for performing a graft polymerization reaction by bringing an irradiated organic polymer substrate into contact with a polymerizable monomer, and a means for continuously or intermittently moving the substrate with slack in the graft polymerization reaction chamber. As apparent from the foregoing description, the graft polymerization reaction chamber here may be a liquid phase graft polymerization reaction bath in which an irradiated substrate is reacted by immersion in a graft monomer solution or an impregnation graft polymerization reaction chamber in which a substrate is reacted at a predetermined temperature for a predetermined period after it is impregnated with a predetermined amount of a graft monomer or a gas phase graft polymerization reaction chamber filled with a graft monomer vapor in which a substrate is treated.

Another aspect of the present invention relates to the graft polymerization apparatus as defined above wherein the means for continuously or intermittently moving the substrate with slack in the graft polymerization reaction chamber has a mechanism for detecting the tension and/or speed at the exit of the substrate after graft polymerization from the graft polymerization reaction chamber and controlling the feeding speed at the feeder of an ungrafted substrate into the graft polymerization reaction chamber and the conveying speed of a substrate at substrate conveyance section in the graft polymerization reaction chamber.

Graft monomers that can be grafted to an organic polymer substrate according to methods of the present invention include any monomers known in radiation-induced graft polymerization such as polymerizable monomers having various functional groups by themselves or polymerizable monomers into which a functional group can be introduced by a secondary reaction after they have been grafted.

When the present invention is applied to prepare an ion exchange filter material, for example, a functional group can be directly introduced into a substrate to give an ion exchange filter material by performing a graft polymerization reaction using a monomer having an ion exchange group such as acrylic acid, methacrylic acid, sodium styrenesulfonate, sodium methallylsulfonate, sodium allylsulfonate, vinylbenzyltrimethylammonium chloride, 2-hydroxyethyl methacrylate or dimethyl acrylamide as a graft monomer.

Monomers into which an ion exchange group can be introduced by a secondary reaction after radiation-induced graft polymerization include acrylonitrile, acrolein, vinyl pyridine, styrene, chloromethylstyrene, glycidyl methacrylate, etc. For example, an ion exchange material can be obtained by conducting a graft polymerization reaction according to the present invention using glycidyl methacrylate as a monomer to introduce on an organic polymer substrate and then reacting it with a sulfonating agent such as sodium sulfite to introduce a sulfone group or aminating it with diethanolamine.

Methods of the present invention can also be applied to prepare heavy metal adsorbents having a chelate group, catalysts,.affinity chromatography carriers, etc.

The present invention is explained in more detail by the examples below. The present invention is not limited to the following description.

### EXAMPLE 1

A graft reaction apparatus shown in FIG. 1 was used. The graft reaction apparatus has graft reaction bath 2 and washing bath 3, each having a size of: width, 20 cm; length, 40 cm; and height, 60 cm. Three liters of 10% aqueous solution of acrylic acid and 3 liters of pure water were added to the reaction bath and washing bath, respectively. The reaction apparatus also had feed roll 4, which was placed in an irradiated substrate storage vessel, and on which an irradiated substrate in a form of a roll is stocked; wind-up roll 5 by which a substrate after reaction is taken up; and guide rolls 6, which guide movement of substrate sheet in each bath. The interior of the apparatus was isolated from the external atmosphere, and a piping to introduce nitrogen gas was connected to the apparatus. An air diffusion pipe was placed at a lower portion of the reaction bath 2 through which nitrogen bubbling could be conducted. Further, cooling machine which may cool the irradiated substrate storage vessel at −40° C. or lower was provided.

A non-woven fabric composed of a polyethylene fiber having a fiber diameter of 10 μm, a real density of 25 g/m², tensile strength of 3 kgf/5 cm in the shape of fabric sheet of 30 cm width×50 m long was irradiated with γ-ray at 150 kGy in nitrogen. Irradiated non-woven fabric sheet was stocked on feed roll 4 in a storage vessel cooled to a temperature of −40° C. or lower, and 1.5 m of the sheet was fed into the reaction bath. Graft polymerization was conducted at 45° C. for 45 minutes. Reacted non-woven fabric sheet was moved to washing bath and next 1.5 m of the sheet was fed into reaction bath. In such a manner, about 30 m of non-woven fabric sheet was subjected to graft polymerization reaction without any tension being applied to the sheet. The non-woven fabric sheet after passing the washing bath was taken up on wind-up roll 5. After all of the fabric sheet had been taken up on wind-up roll 5, the sheet was immersed in pure water and washed 10 times.

A part of the thus treated non-woven fabric was cut for measurement of a real density. Graft rate of the fabric was calculated based on change of a real density to be 31%. A tensile strength of the wet non-woven fabric was measured and found to be as low as 0.9 kgf/5 cm; but it could be handled as a fabric sheet after graft polymerization.

### Comparative Example

In this comparative example, the graft reaction apparatus shown in FIG. 4 was used. The graft reaction apparatus has a similar configuration to the apparatus of FIG. 1 but further has guide rolls 6′ in graft reaction bath 2 and washing bath 3. A dummy non-woven fabric sheet was attached to the fore end of non-woven fabric sheet, and irradiated with γ-ray similar to Example 1. The dummy non-woven fabric sheet was hooked up on wind-up roll 5 via guide rolls 6 and 6′ and tensioned between each guide roll. The non-woven fabric sheet was taken up on wind-up roll 5 at a wind-up speed of 1 m/h while maintaining a tensioned state. A retention time of the sheet in the reaction bath was 45 minutes. Torque at wind-up roll 5 was measured and it was found that a tension at about 7 kgf was applied to the non-woven sheet. At 23 minutes after starting conveyance of the sheet, the non-woven fabric sheet was severed and further conveyance became impossible.

### EXAMPLE 2

The gas-phase graft reaction apparatus shown in FIG. 2 was used. Graft reaction chamber 14 has a size of first width, 30 cm; second width 30 cm width; and height, 30 cm. Feed roll 15 and guide rolls 16 were provided in the reaction chamber 14. The interior of the chamber was isolated from the external atmosphere, and a piping to introduce nitrogen gas was connected to the chamber. A metal mesh was placed at the bottom of the reaction chamber 14 to avoid direct contact of the substrate non-woven fabric with monomer solution 13. Beneath the metal mesh, a monomer solution tray containing graft monomer solution (100% acrylic acid) was placed.

A non-woven fabric composed of a polyethylene fiber having a fiber diameter of 10 μm, a real density of 25 g/m², tensile strength of 3 kgf/5 cm in the shape of fabric sheet of 30 cm wide and 5 m long was irradiated with γ-ray at 150 kGy in nitrogen. The irradiated non-woven fabric sheet was set on feed roll 15 and guide rolls 16 in reaction chamber 14 shown in FIG. 2. Each ends of the sheet were joined to form a ring.

The monomer solution was heated to a temperature of 70° C. Gas phase graft polymerization was conducted while the ring-like substrate non-woven fabric sheet was continuously moved at 0.1 m/min by means of feed roll 15. The Temperature in the graft reaction chamber was 60° C. The graft ratio after a 1-hour reaction was 23±4%. It was found that graft polymerization completed in a relatively uniform manner.

### EXAMPLE 3

The continuous impregnation graft polymerization apparatus shown in FIG. 3 was used. The graft polymerization apparatus has monomer impregnation bath 23; graft polymerization reaction vessel 26 storage vessel in which feed roll 22 was placed; and wind-up vessel in which wind-up roll 27 was placed. Also provided was wringer roll 25, which conveys the substrate after impregnated with monomer solution while wringing the substrate. Guide rolls 28 and 28′ were provided in graft polymerization reaction vessel 26, which guide and convey the substrate. The interior of the apparatus was isolated from the external atmosphere, and a piping to introduce nitrogen gas was connected to each vessel. Monomer impregnation bath 23 contained a 100% solution of glycidyl methacrylate as graft monomer.

A non-woven fabric composed of a polyethylene/polypropylene (sheath/core) fiber having fiber diameter of 15 μm, which has a real density of 45 g/m², a tensile strength in a longitudinal direction of 11 kgf/5 cm in the shape of fabric sheet 30 cm wide and 100 m long was irradiated with γ-ray at 200 kGy in nitrogen. The irradiated non-woven fabric sheet was stocked on feed roll 22 and taken up on wind-up roll 27 via the monomer impregnation bath, wringer roll 25 and guide rolls 28, 28′. Squeezing at wringer roll 25 was regulated to make to impregnate the substrate with about 180% of monomer solution. Five guide rolls were placed at each of an upper portion and lower portion of the vessel. A rotation speed of wringer roll 25, guide rolls 28 and wind-up roll 27 were regulated so that the substrate was transported in the graft polymerization reaction vessel at a speed of 20 m/h while being kept slack. The interior of graft polymerization vessel 26 was maintained at a temperature of 60° C. The reaction time (retention time of the substrate in graft polymerization reaction vessel 26) was about 30 minutes. Graft ratio of the non-woven fabric after reaction was calculated based on an increase of a real density thereof. It was 120 ±10%. Uniform grafted non-woven fabric in the shape of long sheet was obtained.

### Comparative Example 2

Using the same graft polymerization apparatus as in Example 3, graft polymerization was conducted under the same conditions as in Example 3, except that the non-woven fabric substrate was transported in graft polymerization reaction vessel 26 at a speed of 20 m/h while being tensioned between guide rolls 28 and 28′ by regulating a rotation speed of the respective rolls. The torque at wind-up roll 27 was measured and it was found that a tension at about 27 kgf was applied to the non-woven sheet. At 20 minutes after starting conveyance of the sheet, the non-woven fabric sheet was severed and further conveyance became impossible.

### Advantages of the Invention

According to methods of the present invention, a substrate is continuously or intermittently moved with slack during radiation-induced graft polymerization reaction, whereby the substrate can be prevented from being severed by excessive tension. Therefore, radiation-induced graft polymerization can be effectively performed on substrates having low strength or high liquid-retaining tendency such as woven/nonwoven fabrics so that radiation-induced graft polymerization can be applied in a significantly wider range. The problem of inhomogeneous grafting is also solved by continuously or intermittently moving the substrate with slack.

1. A graft polymerization method for polymer substrates comprising performing graft polymerization by bringing an irradiated organic polymer substrate into contact with a polymerizable monomer wherein the organic polymer substrate is continuously or intermittently moved with slack during graft polymerization.

2. The method of claim 1 wherein the substrate is continuously or intermittently moved with slack in a graft polymerization reaction chamber by detecting the tension and/or speed at the exit of the substrate after graft polymerization and controlling the feeding speed at the feeder of an ungrafted substrate and the conveying speed of a substrate at substrate conveyance section in the graft polymerization reaction chamber in response to the detection.

3. A graft polymerization apparatus for polymer substrates comprising a graft polymerization reaction chamber for performing a graft polymerization reaction by bringing an irradiated organic polymer substrate into contact with a polymerizable monomer, and a means for continuously or intermittently moving the substrate with slack in the graft polymerization reaction chamber.

4. The graft polymerization apparatus of claim 3 wherein the means for continuously or intermittently moving the substrate with slack in the graft polymerization reaction chamber has a mechanism for detecting the tension and/or speed at the exit of the substrate after graft polymerization from the graft polymerization reaction chamber and controlling the feeding speed at the feeder of an ungrafted substrate into the graft polymerization reaction chamber and the conveying speed of a substrate at substrate conveyance section in the graft polymerization reaction chamber.
